(19) United States
(12) Patent Application Publication
(10) Pub. No.: US 2008/0117191 A1
(43) Pub. Date: May 22, 2008

(54) Plasma display apparatus and driving device thereof

(76) Inventor: Jun-Hyung Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/822,615

(22) Filed: Jul. 9, 2007

(30) Foreign Application Priority Data
Nov. 20, 2006 (KR) 10-2006-0114691

(51) Int. Cl. G06F 3/038

(52) U.S. Cl. 345/204

(57) ABSTRACT

A plasma display apparatus includes a plasma display panel having a plurality of electrodes, a first power supply, a first driving circuit having a first transistor and a ferrite core in communication with the first transistor, the first transistor being coupled between the first power supply and the electrodes, and a controller in electrical communication with the first driving circuit.

### BACKGROUND OF THE INVENTION

1. Field of the Invention

The present invention relates to a plasma display apparatus and a driving device thereof. In particular, the present invention relates to a plasma display apparatus with an improved operation due to minimized high frequency noise therein.

2. Description of the Related Art

In general, a conventional plasma display apparatus may display texts or images by using gas discharge phenomenon in about several hundred thousands to about several millions of discharge cells arranged in a matrix format in the plasma display apparatus.

One frame of such a conventional plasma display apparatus may be displayed by dividing the discharge cells into a plurality of subfields, so that a combination of weight values of activated subfields may form the frame. Each subfield may include a reset period, an address period, and a sustain period. In the reset period, the wall charge state of a discharge cell may be initialized. In the address period, cells to be activated, i.e., be turned on, may be selected. In the sustain period, sustain discharge may be performed on the selected cells to turn them on. The plasma display apparatus may include a plurality of driving circuits to control the reset, address and sustain periods.

The conventional plurality of driving circuits, e.g., printed circuits boards (PCBs), may have a reduced size in order to decrease manufacturing costs of the plasma display apparatus. The reduced size of the driving circuits may require formation of a plurality of electrical elements, e.g., switches, at decreased predetermined distances from one another in the driving circuit and, thereby, generate potential driving errors and circuit damage due to noise triggered by the close proximity of adjacent electrical elements.

Accordingly there exists a need for a plasma display apparatus having an electrical structure capable of minimizing high frequency noise generated by close proximity between electrical elements during driving thereof.

### SUMMARY OF THE INVENTION

The present invention is therefore directed to a plasma display apparatus, which substantially overcomes one or more of the disadvantages of the related art.

It is therefore a feature of an embodiment of the present invention to provide a plasma display apparatus having a structure capable of minimizing high frequency noise generated between closely positioned electrical elements.

It is another feature of an embodiment of the present invention to provide a driving device of a plasma display apparatus capable of minimizing noise generated between closely positioned electrical elements.

At least one of the above and other features and advantages of the present invention may be realized by providing a plasma display apparatus, including a plasma display panel having a plurality of electrodes, a first power supply, a first driving circuit with a first transistor and a ferrite core in communication with the first transistor, the first transistor being coupled between the first power supply and the electrodes, and a controller in electrical communication with the first driving circuit.

The ferrite core may be coupled to a drain of the first transistor. The first transistor may have a body diode. The first driving circuit may include a second power supply and a second transistor, the second transistor being coupled between the second power supply and the first electrode and in communication with the ferrite core. The plasma display apparatus may further include a second driving circuit having a third transistor and a ferrite core in communication with the third transistor.

In another aspect of the present invention, there is provided a driving device of a plasma display apparatus having a plurality of pairs of first and second electrodes and a plurality of third electrodes positioned orthogonally to the plurality of pairs of first and second electrodes, including a first transistor coupled between the first electrodes and a first power supply generating a first voltage, a second transistor coupled between the first transistor and a second power supply generating a second voltage, a third transistor coupled between the first electrode and a third power supply generating a third voltage, and a first, second and third ferrite cores, each ferrite core coupled to a respective transistor.

The first voltage may be an address data voltage. The second voltage may be a non-scan voltage. The third voltage may be a voltage supplied to the plurality of first electrodes from a predetermined region of a reset period until an address period ends.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a block diagram of a plasma display apparatus according to an exemplary embodiment of the present invention;

FIG. 2 illustrates a schematic diagram of a sustain electrode driver according to an exemplary embodiment of the present invention;

FIG. 3A illustrates a graph of current and voltage in a transistor and a sustain electrode, respectively, of a conventional sustain electrode driver during a transition from an “ON” state to an “OFF” state of the transistor; and

FIG. 3B illustrates a graph of current and voltage in a transistor and a sustain electrode, respectively, of a sustain electrode driver according to an embodiment of the present invention during a transition from an “ON” state to an “OFF” state of the transistor.

### DETAILED DESCRIPTION OF THE INVENTION

Korean Patent Application No. 10-2006-0114691 filed on Nov. 20, 2006, in the Korean Intellectual Property Office, and entitled: “Plasma Display Apparatus and Driving Device Thereof” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements and regions may be exaggerated for clarity of illustration. It will also be understood that when a layer or element is referred to as being “on” another layer or substrate, it can be directly on the other layer or substrate, or intervening layers may also be present. In addition, it will also be understood that when an element is referred to as being “between” two elements, it can be the only element between the two elements, or one or more intervening elements may also be present. It will further be understood that when an element is referred to as being “coupled” to another element, the element may be directly coupled to another element, or one or more intervening elements may also be present. Like reference numerals refer to like elements throughout.

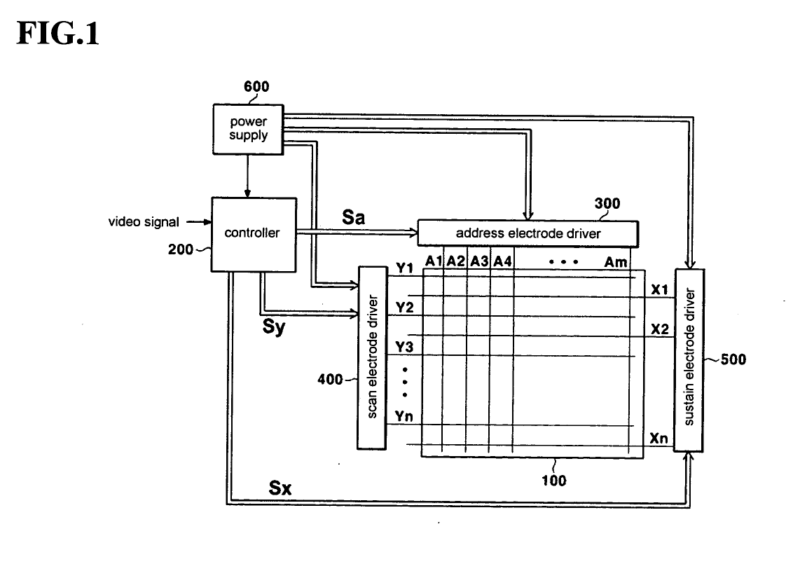

An exemplary embodiment of a plasma display apparatus according to the present invention is more fully described below with reference to FIG. 1. As illustrated in FIG. 1, a plasma display apparatus according to an exemplary embodiment of the present invention may include a plasma display panel (PDP) 100, a controller 200, an address electrode driver 300, a scan electrode driver 400, a sustain electrode driver 500, and a power supply 600 for supplying power to the controller 200 and each of the drivers 300, 400, and 500.

The PDP 100 may include a plurality of address electrodes A1 to Am extending in a vertical direction and a plurality of pairs of sustain electrodes X1 to Xn and scan electrodes Y1 to Yn extending in a horizontal direction. The sustain electrodes X1 to Xn may be formed to correspond to the scan electrodes Y1 to Yn, so that each pair of electrodes, e.g., X1 and Y1, may be connected at one end. The sustain electrodes X1 to Xn and scan electrodes Y1 to Yn may be positioned on a first substrate (not shown) of the PDP 100, while the address electrodes A1 to Am may be positioned on a second substrate (not shown) of the PDP 100. The first and second substrates may be disposed in parallel to one another, so that the sustain electrodes, the scan electrodes, and the address electrodes may be positioned therebetween, and the pairs of sustain and scan electrodes X1 to Xn and Y1 to Yn may orthogonally cross the address electrodes A1 to Am. A plurality of discharge cells may be formed in a space between the first and second substrates at intersection points of the address electrodes A1 to Am and the pairs of sustain and scan electrodes X1 to Xn and Y1 to Yn. It should be noted, however, that other PDP structures are not excluded from the scope of the present invention.

The controller 200 of the plasma display apparatus according to an embodiment of the present invention may be electrically connected to an external apparatus, the power supply 600, and the address, scan and sustain electrode drivers 300, 400 and 500. Accordingly, the controller 200 may receive an input signal from the external apparatus and output a respective output signal to each electrode driver. In particular, the controller 200 may output an address electrode driving control signal Sa, a scan electrode driving control signal Sy, and a sustain electrode driving control signal Sx to the address, scan and sustain electrode drivers 300, 400 and 500, respectively. The controller 200 may drive one frame by dividing it into a plurality of subfields, while each subfield may be operated with respect to a reset period, an address period, and a sustain period. Accordingly, the controller 200 may generate and apply a non-scan voltage VscH, i.e., a DC voltage from the power supply 600, to unselected cells in an address period and to either the scan electrode driver 400 or the sustain electrode driver 500.

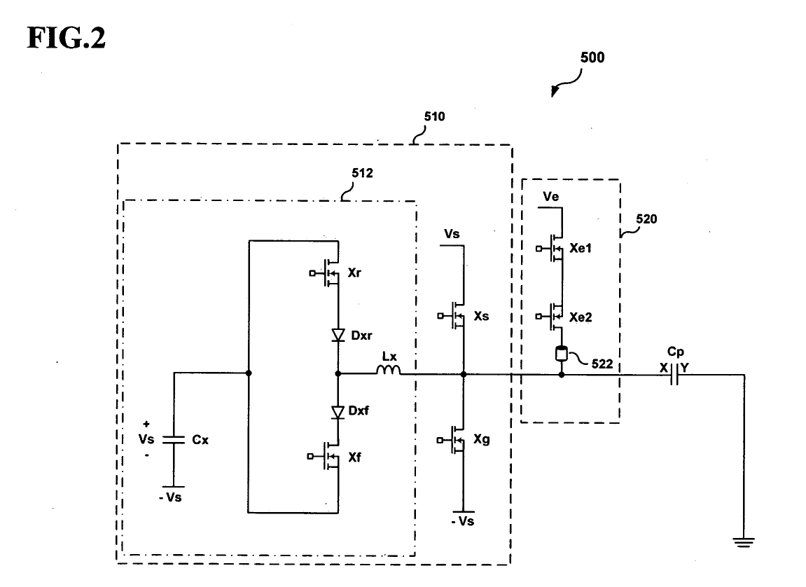

The address electrode driver 300 may receive the address electrode driving control signal Sa from the controller 200 and apply a corresponding display data signal to each address electrode A1 to Am in order to select discharge cells during the address period. The scan electrode driver 400 may receive the scan electrode driving control signal Sy from the controller 200 and apply a corresponding driving voltage to corresponding scan electrodes Y. Similarly, the sustain electrode driver 500 may receive the sustain electrode driving control signal Sx from the controller 200 and apply a corresponding driving voltage to corresponding sustain electrodes X. Either of the drivers 300, 400, and 500 may include a driving circuit with a ferrite core to facilitate high frequency noise elimination, as will be discussed in more detail with respect to FIG. 2. In this respect, it should be noted that the driving circuit with the ferrite core is illustrated in the sustain electrode driver 500 of FIG. 2 for ease of illustration only and other configurations, e.g., formation of a driving circuit and a Ve voltage supply in the scan electrode driver 400, are not excluded from the scope of the present invention.

As illustrated in FIG. 2, the sustain electrode driver 500 may include a sustain driver 510 and a Ve voltage supply 520 in communication with at least one sustain electrode X. It should be noted, however, that FIG. 2 illustrates a single sustain electrode X and a single scan electrode Y for ease of description only and that a use of a plurality of electrodes is not excluded from the scope of the present invention. Additionally, a capacitive component formed by the sustain electrode X and the scan electrode Y is illustrated as a panel capacitor Cp. It should further be noted that a plurality of N-Channel Metal Oxide Semiconductor (NMOS) transistors, i.e., Xr, Xf, Xs, Xg, Xe1 and Xe2, are illustrated as exemplary components only. In other words, other components having similar functions, i.e., transistors having a body directed from a source to a drain as the NMOS transistors, are not excluded from the scope of the present invention. Also, even though each of the Xr, Xf, Xs, Xg, Xe1 and Xe2 transistors illustrates an individual single transistor, a configuration of a driver circuit having a plurality of transistors coupled in parallel is not excluded from the scope of the present invention.

The sustain driver 510 of the sustain electrode driver 500 according to an embodiment of the present invention may include an energy recovery circuit (ERC) 512 and transistors Xs and Xg, so that alternating voltages Vs and (−Vs) may be applied through the transistors Xs and Xg, respectively, to the sustain electrode X during the sustain period.

The power recovery circuit 512 may include a capacitor Cx having a first end connected to a power supply (−Vs) supplying a (−Vs) voltage and a second end connected to a drain of a transistor Xr, a diode Dxr having an anode connected to a source of the transistor Xr and a cathode connected to an anode of a diode Dxf, a transistor Xf having a drain connected to the cathode of the diode Dxf and a source connected to the second end of the capacitor Cx, and an inductor Lc connected between a junction of the diodes Dxr and Dxf and the sustain electrode X.

The transistor Xs may include a drain connected to the power supply Vs supplying a Vs voltage and a source connected to a sustain electrode X. The transistor Xg may include a drain connected to a sustain electrode X and a source connected to a power supply (−Vs) supplying a (−Vs) voltage.

The Ve voltage supply 520 of the sustain electrode driver 500 according to an embodiment of the present invention may include first and second transistors Xe1 and Xe2 and a ferrite core 522. The Ve voltage supply 520 may supply a Ve voltage to the sustain electrode X during the reset and address periods.

The first transistor Xe1 may include a drain connected to a power supply Ve supplying a Ve voltage, and the second transistor Xe2 may include a source connected to the source of the first transistor Xe1. The second transistor Xe2 may be disposed between the first transistor Xe1 and the sustain electrode X to minimize a reverse current path from the sustain electrode X to the power supply Ve via the body diode formed from the source to the drain of the first transistor Xe1.

The ferrite core 522 may be formed at the drain of the second transistor Xe2 to have a cylindrical or a rectangular pipe shape, so that noise components output through the drain of the second transistor Xe2 may pass through the ferrite core 522, i.e., the pipe, and be removed. Without intending to be bound by theory, it is believed that the ferrite core 522 may exhibit excellent magnetic attenuation characteristics and, thereby, be capable of removing high frequency noise components inducing electromagnetic interference (EMI) output through the drain of the second transistor Xe2.

In particular, it is believed that formation of the ferrite core 522 at the drain of the second transistor Xe2 may be advantageous because the Ve voltage supply 520 may generate and supply an instantly increasing or decreasing voltage to the sustain electrode X, as opposed to a gradually increasing or decreasing voltage.

The sustain driver 510 may generate and supply a gradually increasing or decreasing voltage Vs in a ramp waveform through the energy recovery circuit 512 to the sustain electrode X. In particular, the transistors Xs and Xg may be turned on or off after the voltage of the sustain electrode X has reached a voltage level of Vs or (−Vs), respectively. The gradual increase or decrease of voltage through the transistors Xr, Xf, Xs and Xg included in the sustain driver 510 may generate less stress in transistors Xr, Xf, Xs and Xg during turning on/off thereof and, therefore, may trigger less noise.

The Ve voltage supply 520, on the other hand, may generate and supply an instantly increasing or decreasing voltage to the sustain electrode X by turning on/off the first and second transistors Xe1 and Xe2 and the ferrite core 522. However, instant increase or decrease of voltage, as opposed to gradual modification thereof, may generate a peak current and an increase in internal pressure and, thereby, trigger high frequency noise in components positioned in close proximity to Ve voltage supply 520 or in the sustain electrode X. In other words, noise may be generated when either of the transistors is turned on or off for instant voltage regulation, thereby destabilizing the voltage of the sustain electrode X. Accordingly, formation of the ferrite core 522 at the drain of the second transistor Xe2 may significantly reduce the high frequency noise generated in the power supply 520, and thereby provide stable plasma display apparatus operation.

In detail, the Ve voltage supply 520 may supply a Ve or zero voltage to the sustain electrode X by simultaneously turning on/off the transistors Xe1 and Xe2. An action of turning the transistors Xe1 and Xe2 on or off may generate a peak current and an increase in internal pressure in closely positioned transistors, e.g., Xg, thereby inducing a high frequency noise component. Increased high frequency noise may destabilize the voltage of the sustain electrode X and trigger potential erroneous operation and damage in other transistors, e.g., Xr, Xf, Xs and Xg, disposed closely to the transistors Xe1 and Xe2.

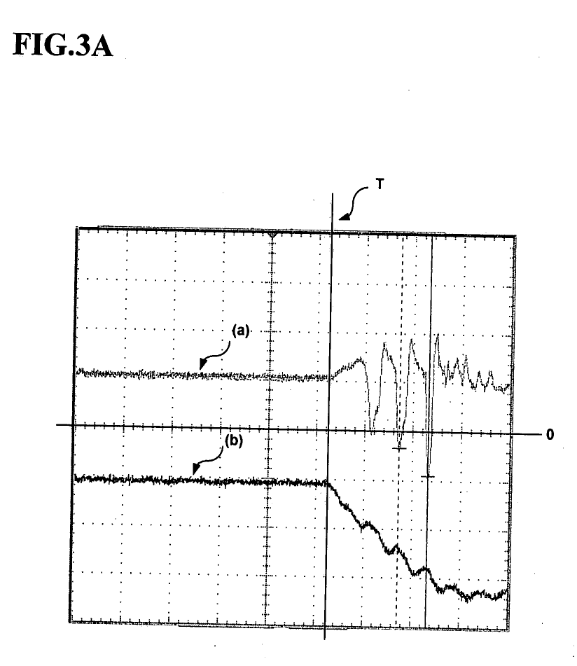

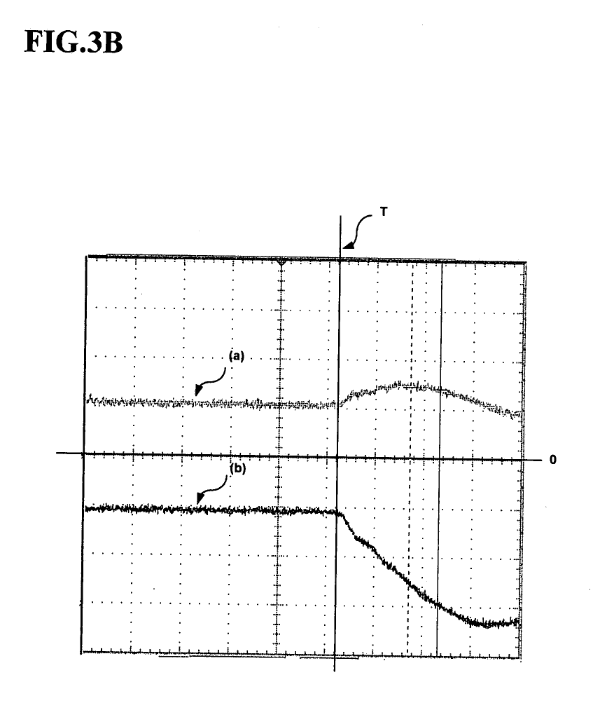

Accordingly, and without intending to be bound by theory, it is believed that formation of the ferrite core 522 at the drain of the second transistor Xe2 may minimize or eliminate the high frequency noise components induced when turning on/off the transistors Xe1 and Xe2, as will be discussed in more detail below with respect to FIGS. 3A-3B, thereby preventing the transistors, i.e., switches, Xr, Xf, Xs and Xg of the sustain driver 510 from generating erroneous operation or from being damaged. It should be noted, however, that even though the present embodiment includes the ferrite core 522 in communication with the drain of the second transistor Xe2, other ferrite core 522 configurations, e.g., a ferrite core 522 in communication with the first transistor Xe1, are not excluded from the scope of the present invention.

FIGS. 3A-3B illustrate waveforms of a current flow in the transistor Xg, i.e., curve (a), and of voltage in the sustain electrode X adjacent to the transistor Xe2, i.e., curve (b), without and with a ferrite core, respectively, with respect to time during a transition from an “ON” state into an “OFF” state of the second transistor Xe2.

As illustrated in FIG. 3A, before time T, the transistors Xg and Xe2 are both “ON,” thereby sustaining a constant current flow from the drain to the source of the transistor Xg and the voltage of the sustain electrode X. Upon turning the second transistor Xe2 off at time T, the current flow from the drain to the source of the transistor Xg increases due to a high frequency noise component generated by turning of the second transistor Xe2. Accordingly, the decreasing voltage of the sustain electrode X, i.e., a voltage drop due to turning “OFF” of the second transistor Xe2, includes peaks due to influence of the high frequency noise component.

In contrast, as illustrated in FIG. 3B, turning “OFF” the second transistor Xe2 at time T in a circuit having a ferrite core may significantly remove noise. In other words, the amount of current flowing from the drain to the source of the transistor Xg is smaller than the amount flowing through the same transistor in FIG. 3A. Accordingly, the voltage drop of the sustain electrode X due to turning “OFF” of the second transistor Xe2 has a more linear character and it exhibits less voltage surges as compared to the voltage drop illustrated in FIG. 3A.

As can be seen from a comparison between a circuit having a ferrite core, i.e., FIG. 3B, and a circuit not having a ferrite core, i.e., FIG. 3A, incorporation of a ferrite core at a drain of the second transistor Xe2 may significantly minimize or eliminate the high frequency noise component triggered in the Xg transistor as a result of turning on/off the second transistor Xe2.

The sustain electrode driver 500 according to an exemplary embodiment of the present invention may further include a scan driver (not shown) supplying a VscL voltage, e.g., a scan voltage or an address data voltage, and a VscH voltage, e.g., a non-scan voltage to the sustain electrode X during an address period. The scan driver may include at least one transistor in communication with a ferrite core. Additionally, the plasma display apparatus according to an embodiment of the present invention may further include connection of a ferrite core to a voltage supply circuit supplying a predetermined voltage to a scan electrode Y and an address electrode A. It should further be noted that the ferrite core 522 may be formed at any source or any drain of a transistor, i.e., as determined with respect to a dispose direction of a corresponding transistor, instantly increasing or decreasing the voltage of the sustain electrode X.

A plasma display apparatus having a Ve voltage supply with a ferrite core according to an exemplary embodiment of the present invention may be advantageous in providing a stable operation characterized by minimized or eliminated high frequency noise components triggered by turning on/off the second transistor Xe2. In other words, the structure of the Ve voltage supply according to an exemplary embodiment of the present invention may provide an improved driving capability of the plasma display apparatus even in circuits having closely positioned elements generating high frequency noise.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display apparatus, comprising:
a plasma display panel including a plurality of electrodes;
a first power supply;
a first driving circuit having a first transistor and a ferrite core in communication with the first transistor, the first transistor being coupled between the first power supply and the electrodes; and
a controller in electrical communication with the first driving circuit.

2. The plasma display apparatus as claimed in claim 1, wherein the ferrite core is coupled to a drain of the first transistor.

3. The plasma display apparatus as claimed in claim 1, wherein the first transistor has a body diode.

4. The plasma display apparatus as claimed in claim 1, wherein the first driving circuit includes a second power supply and a second transistor, the second transistor being coupled between the second power supply and the first electrode, and in communication with the ferrite core.

5. The plasma display apparatus as claimed in claim 4, further comprising a second driving circuit having a third transistor and a ferrite core in communication with the third transistor.

6. A driving device of a plasma display apparatus having a plurality of pairs of first and second electrodes and a plurality of third electrodes orthogonally crossing the plurality of pairs of first and second electrodes, comprising:
a first transistor coupled between the first electrodes and a first power supply generating a first voltage;
a second transistor coupled between the first transistor and a second power supply generating a second voltage;
a third transistor coupled between the first electrode and a third power supply generating a third voltage; and
a first, second and third ferrite cores, each ferrite core coupled to a respective transistor.

7. The driving device as claimed in claim 6, wherein the first voltage is an address data voltage.

8. The driving device as claimed in claim 7, wherein the second voltage is a non-scan voltage.

9. The driving device as claimed in claim 6, wherein the third voltage is a voltage supplied to the plurality of first electrodes from a predetermined region of a reset period until an address period ends.
